(19) United States
(12) Patent Application Publication
(10) Pub. No.: US 2026/0014659 A1
(43) Pub. Date: Jan. 15, 2026

(54) APPARATUS FOR STOPPING A CUTTING DISC

(71) Applicant: KANDO INNOVATION LIMITED, Auckland (NZ)

(72) Inventors: Keith BLENKINSOPP, Auckland (NZ); George Davey MADDEVER, Auckland (NZ)

(21) Appl. No.: 19/139,752

(22) PCT Filed: Jan. 17, 2024
(86) PCT No.: PCT/NZ2024/050002

§ 371 Date: Jun. 16, 2025

(30) Foreign Application Priority Data
Jan. 18, 2023 (NZ) 796439

(51) Int. Cl. B23Q 11/00; A22C 21/00; B23Q 17/24; F16D 55/2255; F16D 65/18; F16D 121/06; F16D 121/14; F16D 121/22; F16D 121/26; F16D 127/02; G06V 20/52

(52) U.S. Cl. CPC B23Q 11/0092; B23Q 17/2438; F16D 55/2255; F16D 65/18; A22C 21/0023; F16D 2121/06; F16D 2121/14; F16D 2121/22; F16D 2121/26; F16D 2127/02; G06V 20/52; G06V 2201/06

(57) ABSTRACT

A machine operator holds a chicken carcass to a circular saw, or a casting to an abrasive cut off wheel. Considerable risk to the hands is minimised with a controllable (about 10 ms) wheel stop mechanism, optically triggered when a gloved finger enters a hazardous zone. (An option uses a conductive glove trigger). An electromagnet releases a powerful spring mechanically linked to opposing brake shoes, forcing them against both sides of a brake disc. The brake disc and the cutting wheel share a shaft but are located in separate compartments. Incident reporting over a network is included.

### FIELD

For a cutting machine having a motor-driven cutting disc or wheel such as a circular saw or an abrasive cut off wheel, the invention provides apparatus to quickly cease rotation of the cutting wheel. Stopping the disc saves the operator's hands from trauma. More generally, the invention describes a machine in which a detector of a hazardous situation is connected to disc brake apparatus capable of quickly stopping a shaft.

### DEFINITIONS

A “braked halt” identifies a procedure used within this invention for stopping the cutting disc or wheel quickly.

“Quick” or “quickly” for the purposes of this document is defined as being “a total stopping time shorter than 20 milliseconds”. The specified time is given by way of example. Longer time intervals may be provided by the same mechanism.

“A circular saw” or “disc saw” describes a rotatable disc bearing a cutting edge that may be a knife edge or may have circumferential teeth, to sever an item into parts. Such machines and cutters are widely used in meat or poultry processing plants, to separate a carcass into portions.

An “abrasive cut off wheel” is a self-sharpening abrasive wheel, typically thin and including reinforcing fibres.

### BACKGROUND

Cutting wheels including circular or disc saws are widely used in industry, for cutting wood or plastics and in the food industry for dismembering carcasses. Unlike carpenter's bench saws, the entire disk may be exposed. Operators of disc saws used in meat or poultry plants continually risk significant trauma to their hands, as shown in a Youtube® video last downloaded on 15 Jan. 2024: https://www.youtube.com/watch?v=KOyc65T50pY. The disc saw apparatus described below may assist with reducing the hazard.

### PRIOR ART

The Applicants have previously disclosed optical surveillance apparatus of this general type within cutting machines; for example in WO2016032345 and WO2023287304.

Murakami in US2010-011926 discusses optical detection but no equivalent mechanism to halt the blade of a circular saw.

Gass in U.S. Pat. No. 20,170,312837 describes conductive detection of glove proximity for a circular saw. All stopping options are applied to the saw blade. One stopping option uses pyrotechnics.

### OBJECT

An object of this invention is to provide apparatus and a method that quickly stops the cutting wheel in response to an event likely to cause trauma to an operator's hand. The event may be an optically detected proximity of the hand to the cutting wheel.

### SUMMARY OF INVENTION

In a first broad aspect the invention provides hazard response apparatus that is included in a disc cutting machine; the cutting machine of a type having a motor and a rotatable cutter shaft supported by bearings from a frame that fixedly supports the cutting disc in the work area, wherein the cutter shaft also fixedly supports a separate brake disc having sides and disposed in a space between a facing set of brake pads mounted on the frame; the hazard response apparatus is adapted to cause, when in use, a first effector to respond to the detected hazard by causing release of stored energy within a spring, consequent motion of the spring causing a linkage to at least one, movable brake pad to press the pads against the sides of the brake disc thereby causing friction to be developed during a braking action and quickly stopping the cutter shaft and the cutting disc within a controlled period of time.

Preferably, the brake disc is supported from the cutter shaft within a compartment separated from the work area.

Alternatives for the cutting disc or wheel are selected from a range including: a cutting wheel having a knife edge, a cutting saw having teeth around the edge, and an abrasive wheel or cutoff wheel.

Preferably, the first effector is selected from a range including a reversibly closable magnetic circuit and an electromagnetic trip device acting on an over-centre latch, said first effector causing, when activated, the quick release of energy to the linkage.

Preferably, the linkage comprises a brake arm pivotally connected to the spring and firmly joined to a rotatable stub axle supported by the frame; the stub axle being in turn firmly joined to the movable brake pad.

Preferably, restoration of stored energy within the spring is provided by a prime mover selected from a range including an electric motor, a hydraulic piston and a pneumatic piston, thereby returning the cutting machine to a safe and stoppable condition before the cutting machine is used.

In a first option, the cutter shaft is directly driven by the motor.

In a second option, the cutter shaft is indirectly driven by a flexible drive selected from a range including belt drives and timing belt drives, operatively coupling the cutter shaft to another shaft that is driven by the motor.

In a second broad aspect, the monitoring apparatus capable in use of detecting an unsafe situation includes a camera and a lens capable when in use of forming at least one image of a hazardous volume comprising a predefined region about the cutting disc and detecting an image of an object having a predefined distinctive appearance within said hazardous volume, and if so detected, of causing the first effector to act.

Preferably, the detected image is discriminated against a background by image analysis apparatus receiving an image from the camera, and the distinctive appearance is selected from a range including colours characteristic of blue gloves, green gloves, yellow gloves, red gloves, fluorescent gloves, and infra-red fluorescent gloves to be worn by the operator.

In an option, the monitoring apparatus includes an apparatus capable of detecting electric contact between a conductive glove worn by the operator and wired to sensing means within the apparatus, and a part of the machine including the cutting disc; contact causing the first effector to act.

In a subsidiary aspect, the monitoring apparatus includes evaluation means for evaluating the elapsed time taken after detection and until the cutting wheel is brought to a stop and preventing the machine from being used if the evaluated time exceeds a predetermined limit.

In a further aspect, the monitoring apparatus capable in use of detecting an unsafe situation also includes a second effector; said second effector comprising a digital incident reporting system configured to prepare and transmit a detailed incident report to a server through a network when caused to respond to the hazard.

Preferably the controlled period of time for the braking action itself is in a range of from 2 to 15 milliseconds.

### NOTES

The description of the invention provided herein is given purely by way of example and is not to be taken in any way as limiting the scope or extent of the invention. In particular references to a “disc saw” or a “cutting wheel” are made by way of example only in order to illustrate the invention, which is applicable to other rotatable cutting machinery. Text or claims references to numbers in accompanying drawings are non-limiting.

The invention has been described in an illustrative manner, and it is to be understood that the terminology which has been used is intended to be in the nature of words of description rather than of limitation.

Throughout this specification unless the text requires otherwise, the word “comprise” and variations such as “comprising” or “comprises” will be understood to imply the inclusion of a stated integer or step or group of integers or steps but not the exclusion of any other integer or step or group of integers or steps. Each document, reference, patent application or patent cited in this text is expressly incorporated herein in their entirety by reference.

Reference to cited material or information cited in the text should not be understood as a concession that the material or information was part of the common general knowledge or was known in New Zealand or in any other country.

### DRAWINGS

FIG. 1 is an oblique view of the stand-alone machine showing the active area and the surveillance extension above it; for a two-shaft version.

FIG. 2 is a diagram of the cutter shaft

FIG. 3 is a conceptual view of the brake mechanism involving an electromagnet.

FIG. 4 is a diagram from a rear aspect of the spring, its frame, and the brake mechanism.

FIG. 5, viewed from an oblique frontal aspect, shows details of the brake pads against the brake disc.

FIG. 6 is a face view of a preferred brake disc.

FIG. 7 is a section through a resilient mount for the brake disc.

FIG. 8 (on sheet 2/5) is an outline of second embodiment (network) connections.

### FIRST EMBODIMENT

This two-shaft machine mulates an existing disc saw used to separate poultry carcasses into two or more parts, while adding safety aspects. The machine is adapted to quickly yet non-destructively bring the cutting disc to a braked halt whenever an emergency stop appears necessary. Monitoring apparatus for detecting an event that requires the cutting disc be stopped, most likely in relation to operator hand movements, is included as an operator safety measure. This specification describes a complete or integrated machine having a cutting wheel or disc. There is a first effector comprising apparatus within the machine for stopping the cutting wheel, and a second, optional, effector comprising networked activity reporting means

### General Layout of Poultry Disc Cutter Machine

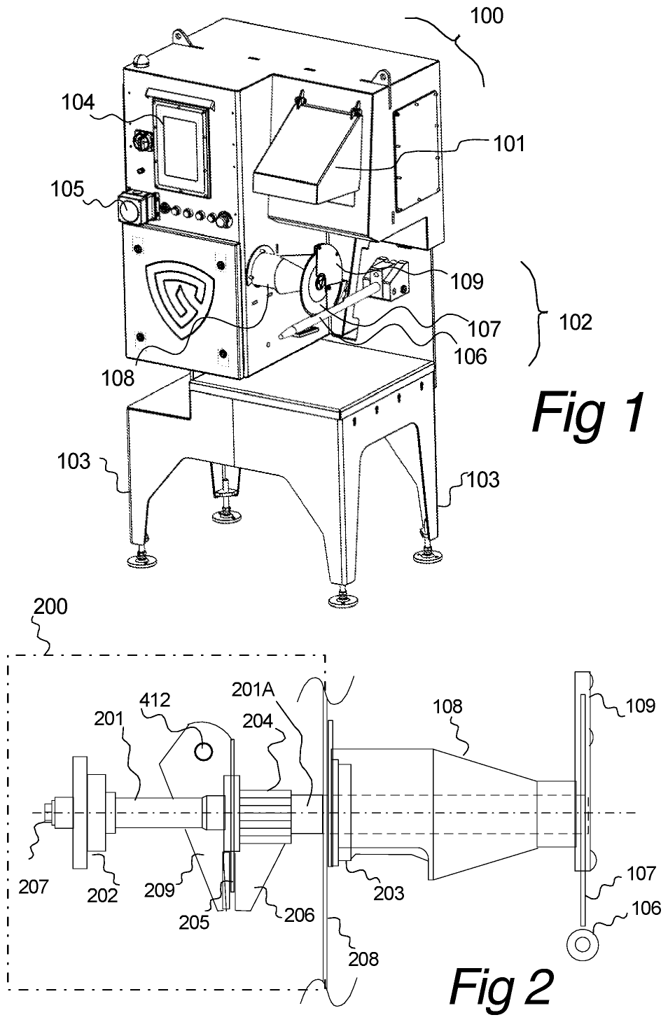

See FIG. 1. The stand-alone poultry disc cutter machine 100 has a cutting disc comprising a cutting wheel 107 located within an open work volume or space 102. A shroud 108 conceals the rotating drive or cutter shaft 201 leading to the cantilevered blade. The cutter shaft is supported by bearings within the machine. The blade is fixed in position within the machine and is placed at a convenient height for a standing operator (who is not shown). Usually, the operator manually holds the carcass before and during the cutting procedure. The passive guide rod 106 is commonly used in machines of this type, to help guide the poultry carcass to and from the blade and to support the carcass against a force imposed by a cutting action at the rotating blade edge.

The operator has a series of control buttons 105 for starting and normally stopping the machine. There is a status display 104. Floor-mounted support legs are shown as 103, and within the work area 102 there is a splash guard or protective shield 109 for the cutting wheel 107.

### Compartments

Unlike some of the prior art, brakes are not applied onto the cutting wheel 107 itself. The work volume 102 including the blade can be regarded as an open compartment. A panel 208 (FIG. 2) isolates the environment of a braking compartment 200 to the left of the shroud 108 from the space 102 so that (1) detritus from sawing such as fat is kept away from the frictional brake, (2) cleaning liquids are kept out of the machine interior, (3) the operator is protected from moving parts including a drive to the cutter shaft and any parts that become forcibly energised within any braking action and (4), the braking compartment 200 may be heated in order to prevent condensation since some work environments and some workpieces are chilled.

### Triggering Event

Apart from a power-down or normal stop in response to an operator command at “Stop” button 105, the machine is capable of quickly performing a braked halt including the cutting disc in response to a triggering event including:
a. Visual surveillance detection by machine vision apparatus (see below) that recognises an operator's coloured gloved hand when brought too close, according to predetermined settings, to the cutting wheel. That initiates a braked halt. See below.
b. Electrical contact detection (an option); if the operator's conductive gloved hand has made electric contact with the cutting wheel. Both visual and electrical sensing can co-exist. A wired connection from the operator's hand to the machine is required. See below.
c. The power supply of the whole machine is interrupted, internally or externally.
d. Self-monitoring of the machine's braking performance has detected a fault.

The triggering events initiating the braked halt are “OR” connected. During normal operation, a stored energy device, namely a strong spring, is held in compression by a electromechanical device, either a directly held electromagnet armature (first embodiment) or a retaining finger extended and held in place using an over-centre linkage by an electromagnet (second embodiment). The trigger acts by cutting a flow of current passing through the electromagnet, immediately releasing the spring. Resulting spring motion causes a mechanism to force a pair of brake shoes together against both sides of a metal brake disc. According to the invention, the brake disc and the cutting wheel or disc are separate, and are in separate compartments.

### Monitoring apparatus: Visual or Optical Surveillance System

In pursuit of operator safety, optical surveillance apparatus is mounted in relation to the cutting wheel 107, above the work volume 102. A preferred version uses a shroud bearing a mirror 101, extended toward the operator in order to reflect views of the cutting wheel 107 as seen from above to an internal camera. On detection of a gloved and thereby coloured hand inside a predetermined hazardous volume in the vicinity of the blade or cutting wheel, a triggering event or SIGNAL is quickly generated by image analysis apparatus. That starts a quick “braked halt” process as described below.

Detection of hand proximity, as opposed to detection of actual hand contact, is an advantage because it reduces the risk of operator trauma, and allows extra braking time. Associated software sets the exact limits of an intangible hazardous volume surrounding the blade in directions toward the operator position and toward each side.

WO2023014232 (PCT/NZ2022/050094) is a pending document describing creation of four spaced-apart viewpoints of the work volume 102 that are brought together by a series of mirrors and a focusing lens on to the image sensor of one machine-vision colour camera as four adjacent yet separate images. An image analysis apparatus is adapted to identify pixels representing the operator's gloved hands when inside the hazardous volume surrounding the imaged cutting disc. with reference to any one image upon the image sensor. Recognition will require appropriate program constants such as for hue discrimination in order to discriminate “glove pixels” in the image by colour or brightness as distinct from “background pixels” arising from the workpiece or the machine. Wearing gloves, typically, blue gloves or green gloves, is in any case required of operators in the food industry. Those colours provide a contrast against meat. Red gloves might be used with a wood saw, or yellow with fish. Alternatives include visually fluorescent gloves, and gloves having infra-red contrast (perhaps derived from fluorescence), which can be seen by a selected camera. The disc cutter machine includes adequate lighting of the work area that may include lighting adapted to excite fluorescent gloves.

The extent of the hazardous zone is preferably interpreted for cutting wheels as meaning “closer than 20 mm to the wheel”. That distance may differ between the left side and the right side of the cutter, for instance. It depends on inadvertent hand movement velocities and total machine reaction time. For example, a designer may evaluate how far a hand could travel during a total machine reaction time of 10 ms, which is typical for this invention, and set the hazardous volume at twice that distance, as a safety margin. The outlines of the hazardous volume will be a relatively vertical-edged cuboid including the cutting disc.

### Timing

This section applies also to the second embodiment. The image analysis process is likely to take 2-4 milliseconds, depending on camera frame refresh for instance; then release of the spring 304 may begin 2 ms later, and finally the rotating disc cutter may be stopped within 5 ms. An immediate braked halt may take a total of 9 to 11 milliseconds. A history of safety protection by the inventors on bandsaws indicates that slipping thumbs, operator distraction and fatigue are likely causes of a braked total. Hand movement may be up to about 2 m·s⁻¹ or 2 mm per millisecond. A 10 ms response time for a hazardous volume boundary set at 20 mm from the cutting edge should be sufficient. When the visual form of the invention is in use the gloved hand can never come into contact with a moving cutting edge.

### Electrical Glove Contact Option

Optionally, a conductive glove is worn and is connected by a current-carrying wire or equivalent to a current source referenced to the machine chassis 100. Onset of conduction between the glove and the cutting disc may be indicated by an abrupt change in the voltage supplied by the machine. A sufficient change, preferably distinguished from one caused by contact between the glove and an earthed workpiece causes the braked halt. It has been noted that operators who have used conductive gloves on a disc cutter are reluctant to change to plain blue latex gloves. The machine vision system and the conductive glove system may be used at the same time. Either optical or conductive sensing will cause the braked halt.

A person skilled in the art may choose to rely solely on electrical glove contact. This invention describes a braked halt mechanism having a faster stopping time than that of the known prior art. at least for non-destructive methods. The total time does not include 2-4 ms for image analysis so may take 7 ms which is a fraction of a revolution.

### Motor and Belt

In one option, cutter shaft 201, supported on bearings, carries a driven pulley, the brake disc and the cantilevered cutting disc near one end. Another shaft having a drive pulley to drive a belt is turned by a motor such as a conventional AC shaded-pole induction motor (not shown), rated at about 750 to 1500 watts. The speed may be near 1500 revs·min^{-1,} when supplied with 50 Hz AC power. Rotational inertia of the motor should be minimised where possible. A smaller and slightly underpowered induction motor may be selected. An induction motor version with an iron cylinder rather than a solid iron armature would have less rotation inertia. Any embodiment could use motors having lower rotational inertia such as: brushless DC motors with permanent magnet armatures; example Brushless-D110BLD600-48 at 600 watts, or air turbine motor at 600-1000 watts (Air Turbine Tools-Boca Raton FLA). They have not been tested.

In the first embodiment, both shafts carry a toothed pulley engaged with a timing belt. One preferred belt is a toothed, reinforced rubber timing belt including fiberglass tensile cords and a neoprene body. It is a generic type: HTD-8M and is 50 mm wide. When the machine executes a braked halt, all rotating parts are brought to a stop at the same time, including the motor through the belt.

As part of a braked halt, motor power is cut. The inventors note that self-braking motors including an internal brake activated when the power is cut are too slow if used alone. In addition, because such a brake may become disconnected by belt failure from the blade upon a different shaft, if the belt failed during self-braking the cutter shaft and cutting disc would not stop.

### Cutter Shaft

The cutter shaft is a strong shaft since substantial forces occur during braking. FIG. 2 is a front clevation diagram showing the shaft 201 and its cantilevered extension 201A supporting the cutting disc 107. A first bearing 202 and a second bearing 203 support the cutter shaft against the chassis of the machine (not shown). The brake disc 205 is aligned with closable brake pads 206, 209, and the driven toothed pulley 204 is aligned with a toothed drive pulley 418 on the first shaft, to receive the drive belt. Both shafts typically rotate at about 1500 rpm. Quite significant forces are carried within the cutter shaft, when spinning at the typical rate, experiences a braked halt. Forces are also transferred to the cutter shaft from the brake disc 205. Significant energy, often over 100 kW, is taken from the cutter shaft and converted into heat.

FIG. 2 shows an elongated machine screw with its head 207 at the left-hand end of the shaft 201 as one way to assemble the cutter shaft 201 in the first embodiment machine. For dismounting the shaft for replacement of either the belt or the brake disc from time to time, the machine screw may be removed. Then the left portion of the shaft 201 as far as the brake disc 205 may be detached for servicing from the mostly concealed right-hand portion 201A.

A second support bearing (203) is provided. Preferably one bearing prevents axial movement of the shaft and the other (such as a roller bearing) tolerates axial shaft movement. Bearing 203 is partly obscured in FIG. 2 by a shroud 108 placed on the operating side of a plate 208, which also separates the compartments (see above). Triangular items 206, 209 are brake shoes or pads. 412 indicates a stub axle comprising part of the brake pad linkage.

The shroud 108 is supported from panel 208 and covers the cantilevered extension of the cutter shaft, extending into the operating area toward the cutting wheel 107. It supports a protective shield 109 about the blade.

### Brake Pads

The preferred pad material is selected from a range including cast iron, stainless steel, copper, phosphor bronze or other forms of bronze; also under test are automotive type pads including fibrous materials embedded in phenolics or acrylics. But the brake disk and brake pads are the site of conversion of a large amount of kinetic energy into heat during several milliseconds.

### Physical Mounting of Spring and Brake Pads

The compressible spring 304 will store the force to be used for closing the brake pads around the brake disc 205 during a braked halt.

The brake pads face each other. Pad 209 can rotate about the stub axle, thereby forcing that pad and pad 206 together by the pressure of the rapidly released spring 304 applied through a linkage during a braked halt. It was found convenient to fix the brake pad 206 in position.

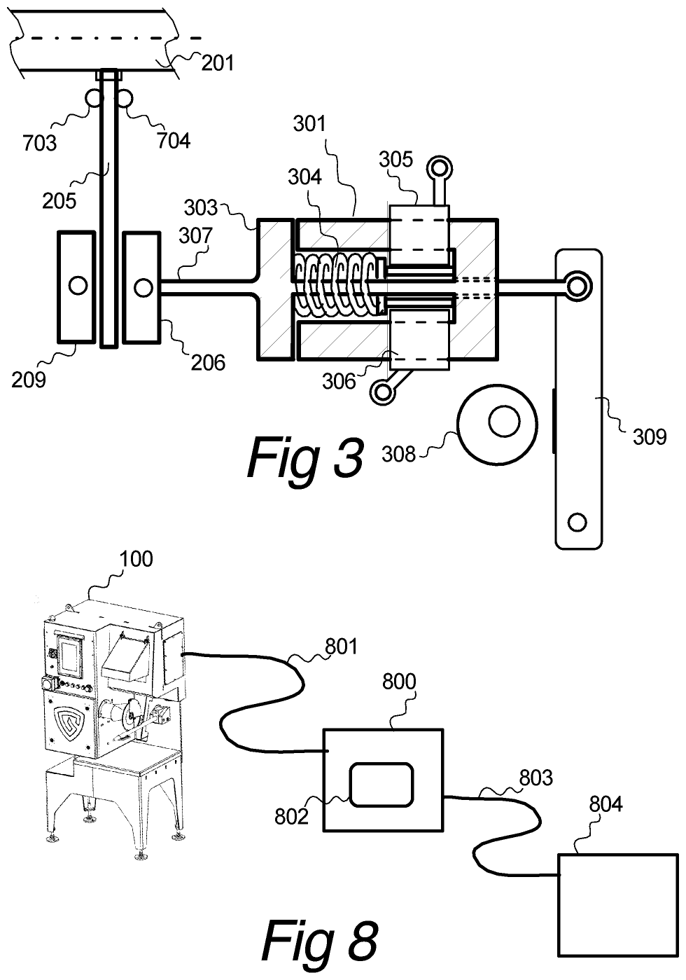

FIG. 3 is a simplified illustrative diagram showing principles of the preferred fail-safe braking mechanism which resembles a magnetic lock on a security door. It is called “fail-safe” because flowing current is maintained while the cutting disc turns. As shown, the state is “Cutting mode; brake released; electromagnet current flowing”. The spring release has been cocked and contact between the brake disc 205 and the brake pads 206, 209 is prevented by a holding action of a magnetic field generated by continuously applied current within windings 305 and 306 and circulating within the magnetically permeable, soft electromagnet core 301 (shown hatched) and including the movable armature 303. The armature is retained against the soft ferromagnetic U-shaped (or possibly pot-shaped) core by the attraction of the magnetic field.

A high yet controlled braking force is applied to the cutter shaft 201 by allowing the armature 303 to be forced to the left, rotating the brake pad 209, by the energy stored in the compressed spring 304 when the current in windings 305 and 306 is interrupted. The spring sets the braking force. The spring surrounds a shaft 307 that is fixed to the armature and supported away from the windings. The shaft is pivotally connected to the movable brake pad 209 to take up wear. Fixed brake pad 206 is also pivotally mounted from a frame of the machine.

FIG. 3 also includes a resetting cam 308. The cam is rotated by a geared-down resetting motor (not shown) to turn through 180 degrees and press with significant force against the pivotally mounted bar 309, pulling shaft 307 into the electromagnet and compressing the spring. At that time the current through the electromagnet is turned on, maintaining the spring in a compressed state. The cam rotates through a second 180 degrees to be out of the way of bar 309 before the brake is applied again. The electromagnet housing includes fins for dissipation of heat.

### Power Interruption

For either embodiment, the “fail-safe” design provides that if the actively maintained electromagnet current is interrupted for any reason such as a general power cut, machine power supply failure, or the like, the armature 303 is released and a braked halt (which does not require an electricity supply) ensues. If a braked halt is not required, simply cutting power to the motor in response to pressing the operator's “OFF” button will let the rotating cutting wheel slow down gradually.

### Brake Disc and its Mount

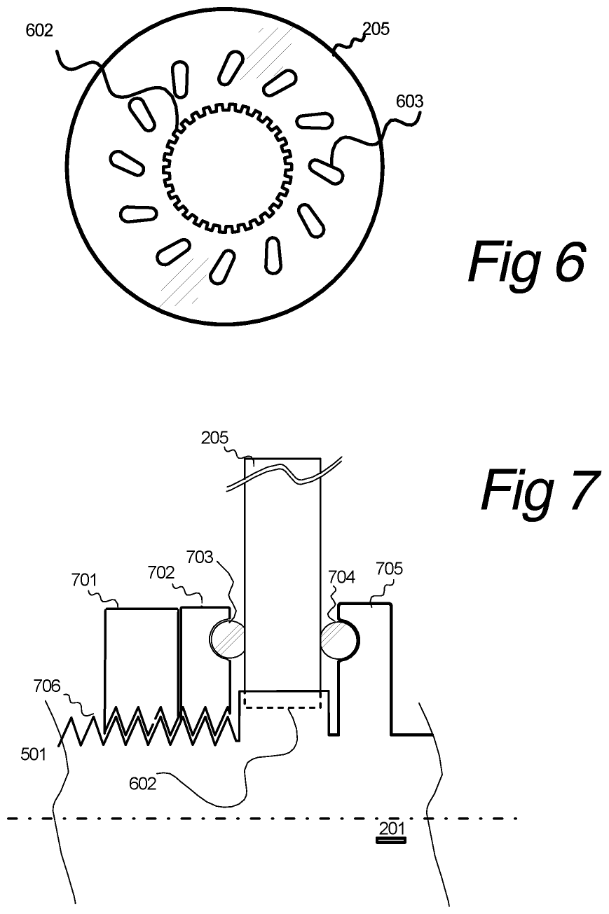

FIG. 6 is a face view drawing of a brake disc 205. It is comprised of a metal such as steel or stainless steel. In this embodiment the disc is about 5 mm thick and 100-120 mm in diameter. The splines 602 about the central aperture of the brake disc couple the braking torque to the sides of corresponding splines formed on the cutter shaft when a braked halt takes place. The brake disc may include a series of perforations such as 603 to assist with dissipation of heat by encouraging air circulation, and to reduce the rotational inertia.

FIG. 7 is a section showing part of a self-centering resilient mount that allows the brake disc 205 some side-to-side movement, while maintaining positive engagement between the splines during a braked halt. It has been found more convenient to move one brake pad only (see below) and as a result the brake disc tends to be twisted during use by unequal motion of the pads. Two O-ring mounts 702, 705 each include a concentric groove for an O-ring 703, 704. Each “O”-ring becomes compressed against the brake disc adjacent the complementary splines, providing resilience against any twisting action. The adjustable ring may be held in place by a lock nut 701. Splines on the brake disc are used to prevent relative rotation on the cutter shaft.

The chassis of the machine 100 provides strong support for the fixed brake pad 209, bearing supporting the stub axle 412, and the bearings for the cutter shaft 201 supporting the brake disc 205 and the cutting disk 107. The chassis may be formed from a 10 mm thick steel plate using bends and welds for added strength.

### Second Embodiment

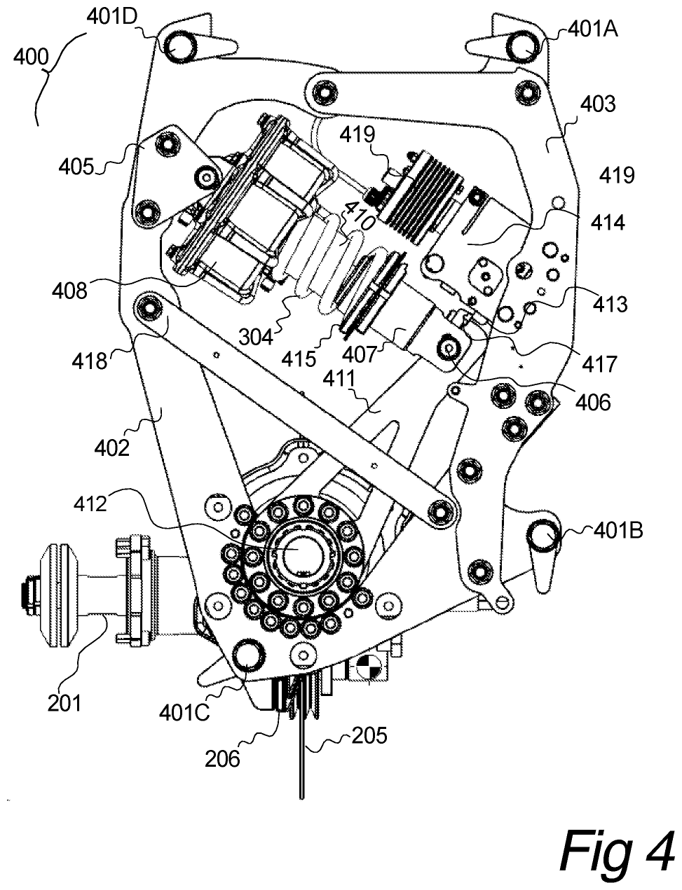

FIG. 4 is an elevation view of the rear side of a robust frame 400 including a stronger helical spring 304, nominally a 650 lb per compression inch spring (11600 kg per meter). The frame, as two connected parts 402, 403 is bolted to a machine frame with bolts 401A, 401B, 401C and 401D. Straps 418 strengthen the frame. Frame 400 is vertically mounted inside the disc cutter machine. It supports a force exerted through a brake arm, closing the brake pads about the brake disk.

### Spring and Cocking

Spring 304 surrounds a telescoping guide shaft 410 and is confined between end stops. One stop is a pneumatic tensioning or cocking cylinder 408. Spring forces typically of about 2000 N have been used, with the force delivered to the brake pads being multiplied by the mechanical leverage provided by the brake arm and shaft dimensions about stub axle 412 in FIGS. 2, 4 and 5. The cylinder is anchored to the frame 402 at pivotable mount 405. The other stop is at a variable collar 415, adjustable to allow the spring length and the delivered force to be changed. The movable end is held through the clevis pivoted at 406 on to a brake arm or beam 411 that is rotatably supported by an attached stub axle (end: 412). The cylinder 408, a telescoping guide shaft 410 inside the spiral spring 304, the spring and the clevis 407 pivot as a unit from the brake arm during cocking and release. a projection or tongue 417 at a side of the clevis is restrained against the spring force by an extended finger 413, held out by an over-centre mechanism that is maintained in place by the current in electromagnet 419.

A relatively low-power electromagnet 419 is used since, unlike the first embodiment, the full force of the spring is not directly held. The over-centre release mechanism within housing 414 holds the finger in place against a spring with a relatively small electromagnet current.

### Release

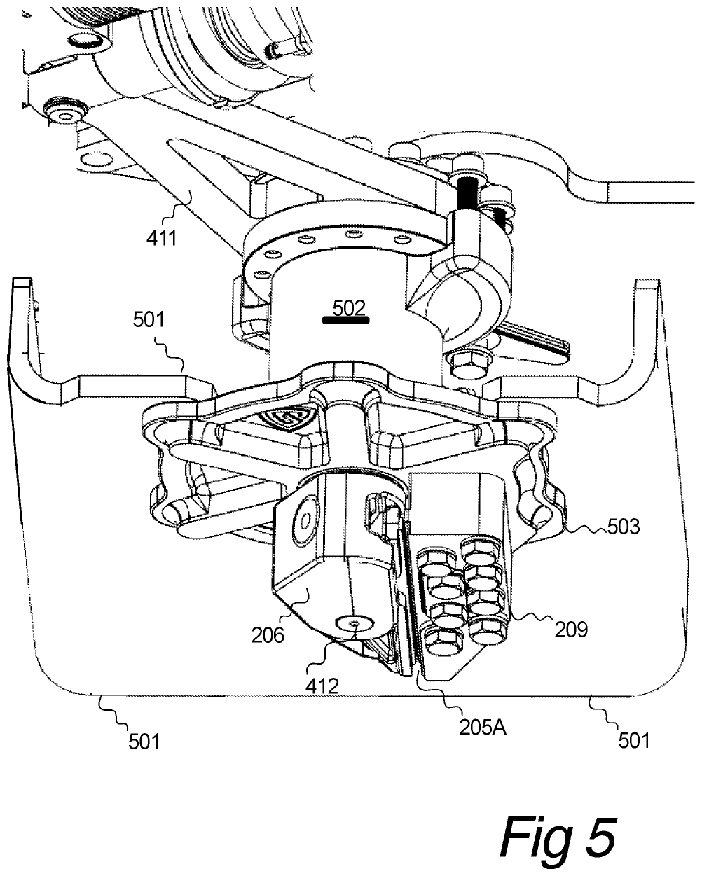

When current in 419 stops, the finger is withdrawn and the now released spring 304 forcibly elongates, moving the pivot 406 and the brake arm or beam 411 in a clockwise direction (FIG. 4 view) about the stub axle, and rotating the firmly connected brake pad 206 (see FIG. 5). The partly obscured brake disc 205 which is held on to partly obscured cutter shaft 201 becomes clamped between the two pads. The force of the spring is usefully magnified at the stub axle 412 by the ratio of: brake arm 411 length from pivot to stub axle 412, divided by a proportion of the length of the movable brake pad 206 from the axis of the stub axle. The frictional area of each brake pad is approximately 800 mm².

An advantage of the invention is that the brake is applied with a predetermined force that is set by the characteristics of the compression spring 304, the amount by which the spring is confined, and the above ratio. The duration of braking is controllable from about 2-4 ms upward, by altering the spring pressure using collar 415 or by use of weaker springs. Braking is not a cataclysmic event. An extended time is available thanks to use of optical proximity sensing rather than contact sensing as described above under “Timing”.

FIG. 5 is an oblique frontal diagram including part of a frame 501, the movable brake pad 206 and stationary pad 209; on each side of space 205A occupied by the brake disc 205 (not shown). 502 is a cover over bearings that surround and supporting the stub axle. Casting 503 is an end support for those bearings. The stub axle transfers rotation of the brake arm 411 to pad 206. It is an advantage to have a relatively long yet sturdy stub axle which, with its bearings, experiences strong forces during use.

In this embodiment, no sideways resilience is provided between the brake disc 205 and cutter shaft 201. The disc is bolted to a collar surrounding the shaft. The disc may flex during a braked halt.

A solid-state switch such as a suitably rated and transient-protected power MOSFET may be connected so as to short the coil of the electromagnet when its control electrode is driven ON. That speeds collapse of the magnetic field of the electromagnet, quickly dissipating the induced power within the resistance of the windings and quickly retracting finger 413.

### Internal Checks

The machine includes transducers for monitoring and safety purposes; for example to report rotation of the drive shaft, to report rotation and stopping rate of the cutter shaft, to report linear movement of the spring 304 (or a strain gauge may be used to report compression of the spring), and to report motion of the movable brake pad 209. It would be unsafe if the time to perform a braked halt was too long. In that case the machine is disabled until the cause is located and rectified by a service person. A routine service call may be placed after a predetermined number of emergency stops.

It has been found useful to control each disc cutter with an internal industrial PC having ample capacity for managing functions including test runs, controlling and monitoring the operator's use, and the essential image processing. The PC drives an operator display 104. It should frequently carry out self-test procedures in case a component is not performing properly, which may lead to a dangerous condition.

### Data and Reports

This “second effector” or managerial safety function is a useful attribute for the disc cutter. As shown in FIG. 8, the internal PC of the disc cutter machine 100 records and may immediately report every occurrence of the braked halt function over a local network 801 to a local server 800 with a supervisor display 802. The report may be sent further, using another network 803 to another server 804. Each disc cutter may have its own URL or internet address. Typically, each report identifies the operator and the machine, the site, the time and date, environmental conditions, a report on motor loading, and may include a short video of the images collected before each braked halt. For example a supervisor having a display dashboard 802 will be informed if an operator is making an unusually large number of braked halts during a shift. The supervisor may take remedial action. Replay of the video might be evidence that injury has been averted. For that purpose, the industrial PC is programmed to save the latest set of images that had been analysed, as a video clip, for the report.

### Example PC Process Steps

1. The operating area is lit. (It is assumed that the operator has entered a name).
2. The “most recent braked halt time” is reviewed. If the machine did not brake quickly enough, use is prevented until the machine is serviced.
3. The machine-vision apparatus is self-checked, or perhaps by the operator bringing a gloved hand toward the edge of the stationary cutting wheel. Proximity detection at this time may comprise audible or visual signals, or both. If effective, work may begin.
4. The spring is compressed and will be held during use of the machine by maintaining the electromagnet current and holding finger 417 in the extended position.
6. The cutting wheel motor can be run and the cutter is used.
7. The process is stopped either with a braked halt, withdrawing finger 417 or with a normal halt. Sequence of a steps for a braked halt:
1. Detection of a hazardous situation, such as comprising any part of a gloved hand being imaged within a threshold area about the cutting disc by the machine vision apparatus results in generation of an internal SIGNAL which is a decision to carry out a braked halt. (Electrical conduction may also be sensed.)
2. The holding current in electromagnet 419 is interrupted; the spring 304 is released, movement of beam 411 along an arc centered on the stub axle 412 causes the movable brake pad 209 to press the brake disc against the fixed brake pad, quickly bringing the cutter shaft to a halt.
3. The motor drive power is also cut. The time to become stopped is compared against a predetermined value, to ensure that the machine is stopping quickly.
4. The apparatus is ready to pass through the Starting steps again.

### Other Embodiments

For an even faster stopping time, use a greater spring force applied to the brake pads or different pads, always subject to machine frame stress. For a slower stopping time, reduce the force. For example the strength of the spring or the amount of pre-load can be varied, the brake pad material or the amount of multiplication of the force provided by a particular geometry of lever arms and pivot centre may be varied.

The motor may be directly, or through a resilient in-line coupling, connected to the cutter shaft carrying the cutting wheel, when no other shaft is used. Suitable motors include brushless DC motors having lower rotational inertia. Air turbine motors may be used.

At least some abrasive cut off wheels have been found tolerant to quick braking halts.

### ADVANTAGES

This invention provides a suitably fast response if an operator's gloved hand is detected within a volume defined by proximity to a cutter blade. Detection causes the cutter wheel to stop turning before the hand can reach the blade.

Optionally, incursion is detected by electrical contact with a conductive glove.

In the event of a power cut, the disc brake is activated.

The machine stays in a fail-safe condition if the belt to a cutter shaft breaks during a braked halt.

If incomplete compression of the spring is detected by a transducer, the machine enters a “safe state”. The motor can't be run. Or, if a previous braked halt took too long, the motor can't be run, pending repair.

No sacrificial components are consumed in a braked halt and the machine returns to a “ready” state within seconds.

The actual braking time may be raised from a nominal 2-4 ms, and may be longer than that of an electrical conductivity type of machine, since “proximity of hand to blade” occurs sooner than “actual contact of hand with blade”.

Particulate matter from the brake apparatus does not enter the work area since the brake mechanism is located in a separate compartment. Likewise, the brake mechanism is not contaminated by materials being cut, or from periodic washing down, and the brake compartment may be heated to avoid condensation.

Finally it will be understood that the scope of this invention as described and/or illustrated herein is not limited to the specified embodiments. Those of skill will appreciate that various modifications, additions, known equivalents, and substitutions are possible without departing from the scope and spirit of the invention as set forth in the following claims.

1-12. (canceled)

13. A hazard response apparatus in a disc cutting machine; the disc cutting machine having a motor and a rotatable cutter shaft supported on a frame by bearings that support the rotatable cutting shaft and an attached cutting disc in a work area, wherein the rotatable cutter shaft also supports a separate brake disc having sides and disposed in a space between a facing set of brake pads mounted on the frame; the hazard response apparatus being adapted to cause, when in use, a first effector to respond to the detected hazard by causing release of stored energy within a spring, consequent motion of the spring causing a linkage to at least one, movable brake pad to press the pads against the sides of the brake disc thereby causing friction to be developed during a braking action and stopping the cutter shaft and the cutting disc within a controlled period of time.

14. The hazard response apparatus according to claim 13, wherein the brake disc is supported on the cutter shaft within a compartment separated from the work area.

15. The hazard response apparatus according to claim 13, wherein the first effector is selected from the group consisting of a reversibly closable magnetic circuit and an electromagnetic trip device acting on an over-centre latch, said first effector causing, when activated, the quick release of energy to the linkage.

16. The hazard response apparatus according to claim 13, wherein the linkage comprises a brake arm pivotally connected to the spring and firmly joined to a rotatable stub axle supported by the frame; the stub axle being in turn firmly joined to the movable brake pad.

17. The hazard response apparatus according to claim 13, wherein a prime mover selected from the group consisting of an electric motor, a hydraulic piston and a pneumatic piston is disposed in a configuration adapted for restoration of stored energy within the spring, thereby returning the cutting machine to a safe and stoppable condition before the cutting machine is used.

18. The hazard response apparatus according to claim 13, wherein the cutter shaft is directly driven by the motor.

19. The hazard response apparatus according to claim 13, wherein the cutter shaft is indirectly driven by a flexible drive selected from the group consisting of belt drives and timing belt drives, operatively coupling the cutter shaft to another shaft that is driven by the motor.

20. The hazard response apparatus according to claim 13, wherein the monitoring apparatus capable in use of detecting an unsafe situation includes a camera and a lens capable when in use of forming at least one image of a hazardous volume comprising a predefined region about the cutting disc and detecting an image of an object having a predefined distinctive appearance within said hazardous volume, and if so detected, of causing the first effector to act.

21. The hazard response apparatus according to claim 20, wherein the detected image is discriminated against a background by image analysis apparatus receiving an image from the camera, and the distinctive appearance is selected from the group consisting of colours characteristic of blue gloves, green gloves, yellow gloves, red gloves, fluorescent gloves, or infra-red fluorescent gloves to be worn by the operator.

22. The hazard response apparatus according to claim 13, wherein the monitoring apparatus includes an apparatus capable of detecting electric contact between a conductive glove worn by the operator and wired to sensing means within the apparatus, and a part of the machine including the cutting disc; contact causing the first effector to act.

23. The hazard response apparatus as claimed in claim 20, wherein the apparatus includes evaluation means for evaluating the elapsed time taken after detection and until the cutting wheel is brought to a stop and preventing the machine from being used if the evaluated time exceeds a predetermined limit.

24. The hazard response apparatus as claimed in claim 22, wherein the apparatus includes evaluation means for evaluating the elapsed time taken after detection and until the cutting wheel is brought to a stop and preventing the machine from being used if the evaluated time exceeds a predetermined limit.

25. The hazard response apparatus as claimed in claim 20, wherein the monitoring apparatus capable in use of detecting an unsafe situation also includes a second effector; said second effector comprising a digital incident reporting system configured to prepare and transmit a detailed incident report to a server through a network when caused to respond to the hazard.

26. The hazard response apparatus as claimed in claim 22, wherein the monitoring apparatus capable in use of detecting an unsafe situation also includes a second effector; said second effector comprising a digital incident reporting system configured to prepare and transmit a detailed incident report to a server through a network when caused to respond to the hazard.

27. The hazard response apparatus according to claim 13, wherein the cutting disc is selected from the group consisting of a toothed disc saw, a sharp-edged disc, an abrasive wheel and a cutoff wheel.

28. The hazard response apparatus according to claim 13, wherein the controlled period of time is less than 20 milliseconds.

29. The hazard response apparatus according to claim 28, wherein the controlled period of time is in a range of from 2 to 15 milliseconds.
